(19) United States
(12) Patent Application Publication
(10) Pub. No.: US 2005/0208943 A1
(43) Pub. Date: Sep. 22, 2005

(54) Apparatus and method for handover between two networks during an ongoing communication

(76) Inventors: Mark E. Pecen, Palatine, IL (US); Sanjay Gupta, Lakewood, IL (US); Stephen L. Spear, Skokie, IL (US)

Correspondence Address: MOTOROLA INC, 600 NORTH US HIGHWAY 45, ROOM AS437, LIBERTYVILLE, IL, 60048-5343, US

(21) Appl. No.: 10/804,292

(22) Filed: Mar. 19, 2004

(51) Int. Cl. H04B 17/02

(52) U.S. Cl. 455/436; 455/426.1; 455/466

(57) ABSTRACT

A method and apparatus for handover of a communication device between a first network and a second network while the communication device is in an ongoing communication. The communication device can register with the second network. The communication device can also enter an ongoing communication via the first network. The communication device can send a transfer request to the first network to request a handover of the ongoing communication between the first network and the second network without interrupting the ongoing communication.

### BACKGROUND

1. Field

The present disclosure is directed to a method and apparatus for handover of a communication device between a first network and a second network while the communication device is in an ongoing communication. More particularly, the present disclosure is directed to handover from a first network in which a communication device is in an ongoing communication to a second network that uses a different mode of communication from the first network.

2. Description of Related Art

Presently, mobile communication devices can travel between cells of a network on which the mobile communication device is operating. A mobile communication device can maintain an ongoing communication, such as a call, when traveling between cells of the same network by using handover between the cells. This handover can be done because both the current network and the mobile communication device have knowledge of the identities of the surrounding bases stations in adjacent cells that may be valid handover candidates within the current network. This knowledge is necessary because the mobile communication device must perform measurements on the radio-frequency signal received from the candidates, maintain synchronization to all the candidates, maintain a measurement database containing average measurements of such candidates, and send a measurement report to the current network. The current network uses the measurement report sent by the mobile to make an intelligent decision as to which base station would be the most acceptable candidate. For example, the current network can determine the identity of any appropriate handover candidates in the mobile communication device's current operating environment. The current network can then use a neighbor list to inform the mobile communication device of potential handover candidates.

Unfortunately, present networks do not allow handover of a mobile communication device to another network while the mobile communication device is in an ongoing communication. For example, an ongoing communication cannot be transferred from a cellular network to a wireless local area network. As another example, an ongoing communication cannot be transferred from a first radio access network to a second radio access network that is uncoordinated or has a different mode of communication with the first radio access network.

Thus, there is a need for handover from a first network in which a communication device is in an ongoing communication to a second network that uses a different mode of communication from the first network.

### BRIEF DESCRIPTION OF THE DRAWINGS

The embodiments of the present invention will be described with reference to the following figures, wherein like numerals designate like elements, and wherein:

FIG. 1 is an exemplary block diagram of a system according to one embodiment;

FIG. 2 is an exemplary block diagram of a communication device according to one embodiment;

FIG. 3 is an exemplary block diagram of a first network controller according to one embodiment;

FIG. 4 is an exemplary flowchart outlining the operation of a communication device according to one embodiment; and

FIG. 5 is an exemplary flowchart outlining the operation of a controller at the first radio access network or at the core network according to one embodiment.

### DETAILED DESCRIPTION

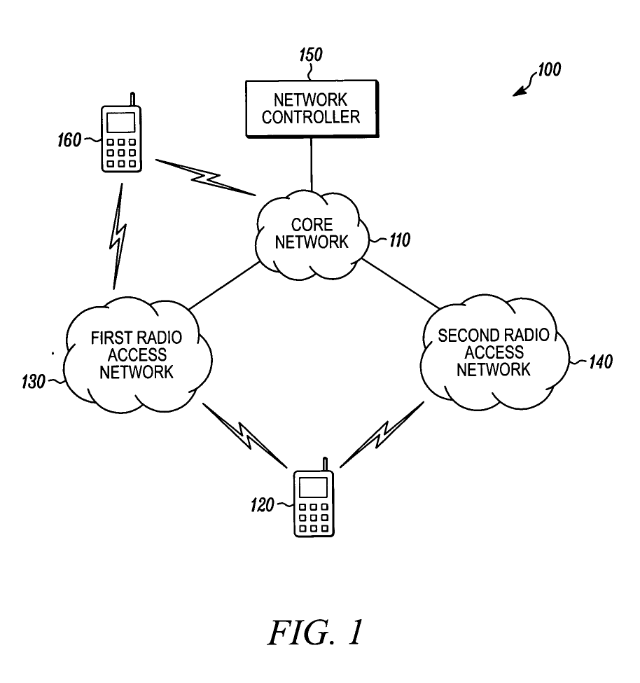

FIG. 1 is an exemplary block diagram of a system 100 according to one embodiment. The system 100 includes a network controller 150, a core network 110, a first radio access network 130, a second radio access network 140, and one or more terminals 120 and 160. The network controller 150 and/or other network controllers can be located at the core network 110, at the first radio access network 130, and/or at the second radio access network 140. Terminals 120 and 160 may include telephones, wireless telephones, cellular telephones, PDAs, pagers, personal computers, mobile communication devices, or any other device that is capable of sending and receiving communication signals on a network including wireless network. The networks may include any type of network that is capable of sending and receiving signals, such as wireless signals. For example, the networks may include a wireless telecommunications network, a cellular telephone network, a satellite communications network, a wireless local area network, and/or other like communications systems. Furthermore, the networks may include more than one network and may include a plurality of different types of networks. Thus, the networks may include a plurality of data networks, a plurality of telecommunications networks, a combination of data and telecommunications networks and other like communication systems capable of sending and receiving communication signals.

In operation, the terminal 120 can enter an ongoing communication with the terminal 160 via the first radio access network 130 and/or the core network 110. The terminal 120 can come within range of the second radio access network 140, which may overlap the first radio access network 130. The terminal 120 can transfer from the first radio access network 130 to the second radio access network 140 while maintaining the ongoing communication with the terminal 160.

For example, the terminal 120 can transfer to the second radio access network 140 while maintaining the ongoing communication with the terminal 160 by using a source-initiated method of handover by associating a fictitious neighbor value with the second radio access network 140. As an example, a unique frequency can be logically associated with the second radio access network 140. As another example, the terminal 120 and the network 130 or the network 110 can mutually associate an occurrence of a measurement report on the same frequency as the Broadcast Channel (BCCH) carrier of a serving cell in the first radio access network 130, but with a different color code, as a second radio access network frequency in its measurement report. This combination can indicate the presence of an adjacent second radio access network access point and therefore a handover candidate if the measurement parameters meet acceptability criteria.

As another example for handover, a Short Message Service (SMS) may be used to periodically transmit information on second radio access network neighbors. In the presence of second radio access network neighbors on which the terminal 120 has obtained authentication and Internet Protocol (IP) addresses, the terminal 120 can send the following information to a first radio access network Proxy Base Station Controller (BSC): 1) Current cell information, 2) IP address 3) a Temporary Mobile Station Identity (TMSI). This information may be sent in a message via SMS to the Proxy BSC i) periodically or ii) whenever the terminal's IP address is reassigned for some reason. A dummy IP message may be sent periodically to prevent unnecessary consumption of radio and signaling resources.

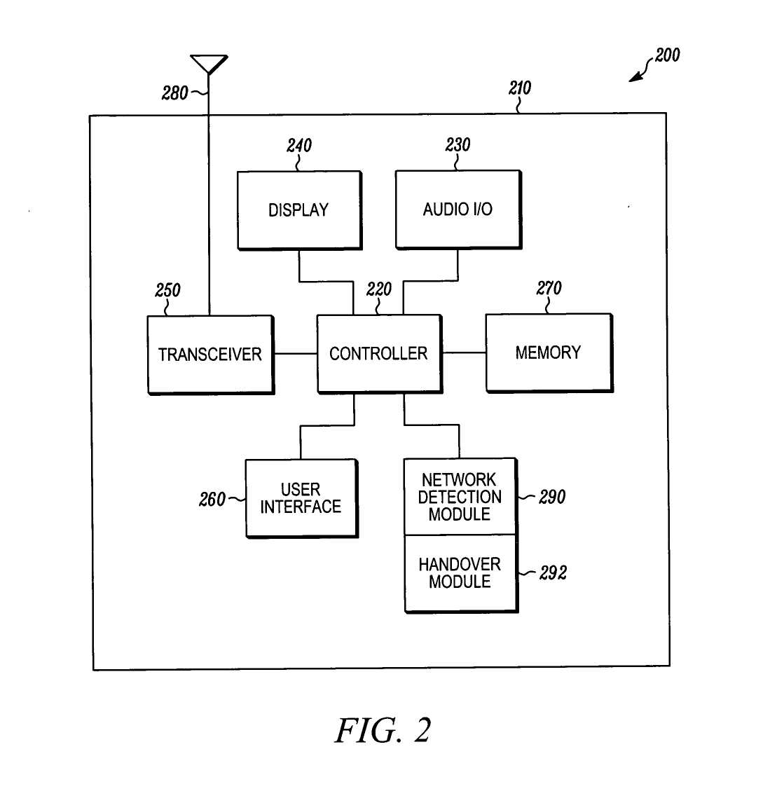

FIG. 2 is an exemplary block diagram of a communication device 200, such as the terminal 120 or the terminal 160, according to one embodiment. The communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, and an antenna 280 coupled to the housing 210 and the transceiver 250. The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and an electronic device. The memory 270 may include a random access memory, a read only memory, an optical memory, a subscriber identity module memory, or any other memory that can be coupled to a communication device.

The communication device 200 can be used for handover from a first radio access network 130 to a second radio access network 140, the first radio access network 130 using a different mode of communication from the second radio access network 140. Accordingly, the controller 220 can be configured to enter an ongoing communication on the first radio access network 130 via the transceiver 250. The communication device can also include network detection module 290 and a handover module 292. The network detection module 290 can be configured to detect the presence of a second radio access network 140, the second radio access network 140 being unregistered with the first radio access network 130 at initial detection of the presence of the second radio access network 140 during the ongoing communication. The second radio access network 140 may be unregistered with the first radio access network 130 in the sense that the first radio access network 130 is unaware of the second radio access network, that neither network can exert control over each other, or that each radio access network may not recognize the other radio access network as a radio access network.

The handover module 292 can be configured to transfer the ongoing communication from the first radio access network 130 to the second radio access network 140. According to one embodiment, neither the first radio access network 130 nor the second radio access network 140 are able to exert control over each other. The first radio access network 130 may be a cellular radio access network and the second radio access network 140 may be a wireless local area network. The second radio access network 140 may be unregistered with the first radio access network 130 by the first radio access network 130 not initially having information on the second radio access network 140 when the network detection module 290 detects the presence of the second radio access network 140. The controller 220 can also be configured to enter a the ongoing communication by entering a call while operating in a serving cell of the first radio access network 130 and be further configured to generate and transmit a measurement report including a fictitious neighbor value associated with the serving cell. The fictitious neighbor value can include a same radio frequency value as a broadcast channel carrier of the serving cell with a different color code from the broadcast channel carrier of the serving cell, can include a frequency value not used as a broadcast channel of the first radio access network of the serving cell, or can include any other useful fictitious neighbor value. The color code can be an information field including a first three bits of a base station identity code. The controller 220 can further be configured to set up a data session with the second radio access network 140 and query the second radio access network 140 for information relevant to a circuit handover. The controller 220 can further be configured to transmit a message via a messaging service, the message including information on the second radio access network 140, the message indicating a desire to transfer the call from the first radio access network 130 to the second radio access network 140. The messaging service can be a short messaging service and the message can be is a short messaging service message. The communication device controller 220 can be further configured to perform additional steps of the flowcharts illustrated below. Additionally, the network detection module 290 and the handover module 292 may be software or hardware modules and may be autonomous, may be located on the controller 220, or may be located in the memory 270.

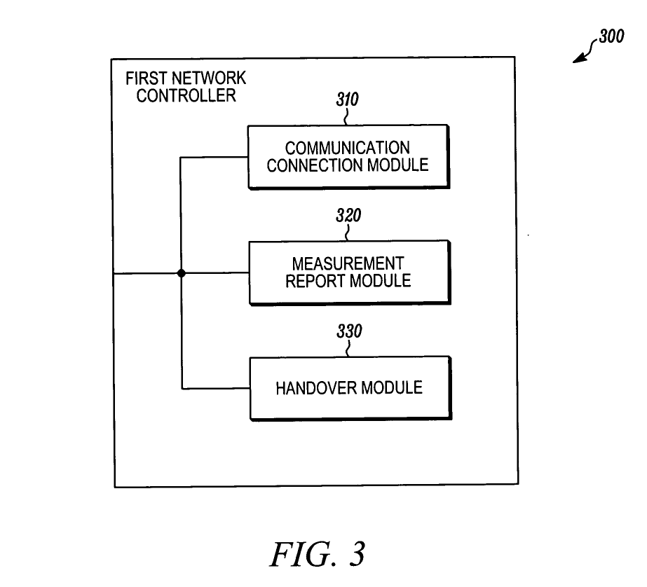

FIG. 3 is an exemplary block diagram of a first network controller 300, such as the network controller 150, located at the first radio access network 130, according to one embodiment. The first network controller 300 can be in the first radio access network 130 for handover from the first radio access network 130 to the second radio access network 140, the first radio access network 130 using a different mode of communication from the second radio access network 140. The first network controller 300 can include a communication connection module 310 configured to connect an ongoing communication of the communication device in a serving cell on the first radio access network 130, a measurement report module 320 configured to receive a measurement report, and a handover module 330 configured to transfer the ongoing communication from the first radio access network 130 to the second radio access network 140. The measurement report can include a fictitious neighbor value. The fictitious neighbor value can include a same radio frequency value as a broadcast channel carrier of the serving cell with a different color code from the broadcast channel carrier of the serving cell, can include a frequency value not used as a broadcast channel of the first radio access network of the serving cell, or can include any other useful value. The color code can be an information field including a first three bits of a base station identity code. The second radio access network 140 can be a wireless local area network and the first radio access network 130 can be a cellular radio access network. The ongoing communication can be a data session, a call, or both. The ongoing communication can be a connection between the communication device 200 and a connected party 160. The ongoing communication can be transferred from the first radio access network 130 to the second radio access network 140 by switching the connection between the communication device 200 and the connected party 160 via the first radio access network 130 to a connection between the communication device 200 and the connected party 160 via the second radio access network 140. The ongoing communication can be transferred from the first radio access network 130 to the second radio access network 140 by bypassing the first radio access network 130 or by a connection from the first radio access network 130 to the second radio access network 140. The first network controller 300 can be further configured to perform additional steps of the flowcharts illustrated below. Additionally, the communication connection module 310, the measurement report module 320, and/or the handover module 330 may be software or hardware modules and may be autonomous or combined on the first network controller 300.

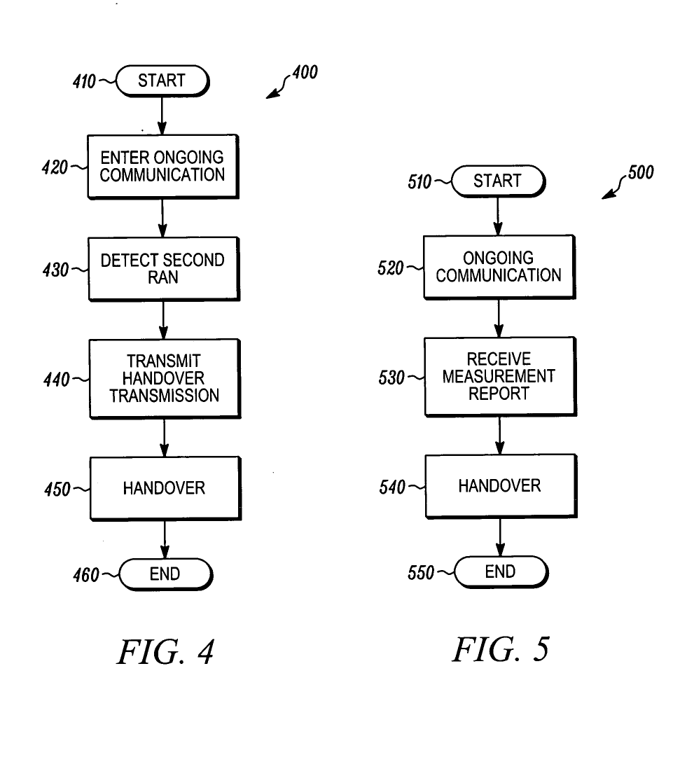

FIG. 4 is an exemplary flowchart 400 outlining the operation of the communication device 200 according to one embodiment. For example, the flowchart 400 outlines a method in the communication device 200 for handover from a first radio access network 130 to a second radio access network 140, the first radio access network 130 using a different mode of communication from the second radio access network 140. In step 410, the flowchart begins. In step 420, the communication device 200 enters an ongoing communication on the first radio access network 130. In step 430, the communication device 200 detects the presence of a second radio access network 140, the second radio access network 140 being unregistered with the first radio access network 130 at initial detection of the presence of the second radio access network 140 while in the ongoing communication. In step 450, the communication device 200 transfers the ongoing communication from the first radio access network 130 to the second radio access network 140. According to one embodiment, neither the first radio access network 130 nor the second radio access network 140 are able to exert control over the other at least before the second radio access network 140 is detected. The first radio access network 130 may be a cellular radio access network and the second radio access network 140 may be a wireless local area network. The second radio access network 140 is unregistered with the first radio access network 130 in the sense that the first radio access network 130 does not initially have information on the second radio access network 140 at detection of the second radio access network 140 by the communication device 200.

Entering an ongoing communication can include entering a call while operating in a serving cell of the first radio access network 130. The method can include, at step 440, transmitting a handover transmission. For example, the handover transmission can include a measurement report including a fictitious neighbor value. The fictitious neighbor value can be an identifiable value associated with the serving cell, a same radio frequency value as a broadcast channel carrier of the serving cell with a different color code from the broadcast channel carrier of the serving cell, a frequency value not used as a broadcast channel of the first radio access network of the serving cell, or another value for indicating a second radio access network that is initially unregistered with a current radio access network. The color code can be an information field including a first three bits of a base station identity code.

The step of transmitting a handover transmission can include setting up a data session with the second radio access network and querying the second radio access network for information relevant to a circuit handover. The step of transmitting a handover transmission can further include transmitting a message via a messaging service, the message including information on the second radio access network 140, the message indicating a desire to transfer the call from the first radio access network 130 to the second radio access network 140. The messaging service can be a short messaging service and the message can be a short messaging service message. In step 460, the flowchart 400 ends.

FIG. 5 is an exemplary flowchart 500 outlining the operation of a controller at the first radio access network 130 or at the core network 110 according to one embodiment. For example, the flowchart 500 outlines a method in a radio access network for handover from a first radio access network 130 to a second radio access network 140, the first radio access network 130 using a different mode of communication from the second radio access network 140. At step 510, the flowchart begins. In step 520, the controller recognizes an ongoing call of the communication device 200 in a serving cell on the first radio access network 130. For example, the communication device 200 may enter the serving cell while in an ongoing communication, may place an outgoing communication while in the serving call, or may receive an ongoing communication while in the serving cell. In step 530, the controller receives measurement report including a fictitious neighbor value. In step 540, the controller transfers the ongoing communication from the first radio access network 130 to the second radio access network 140. The fictitious neighbor value can be an identifiable value associated with the serving cell of the first radio access network. The fictitious neighbor value can also be the same frequency value as a broadcast channel carrier of the serving cell with a different color code from the broadcast channel carrier of the serving cell. The fictitious neighbor value can also be a frequency value not used as a broadcast channel of the first radio access network 130 of the serving cell. The second radio access network 140 can be a wireless local area network and the first radio access network can be a cellular radio access network. The ongoing communication can be a data session, a call, and/or both. The color code can be an information field including a first three bits of a base station identity code. The ongoing communication can be a connection between the communication device 200 and a connected party 160. Transferring the ongoing communication from the first radio access network 130 to the second radio access network 140 can include switching the connection between the communication device 200 and the connected party 160 via the first radio access network 130 to a connection between the communication device 200 and the connected party 160 via the second radio access network 140. Transferring the ongoing communication from the first radio access network 130 to the second radio access network 140 can also include bypassing the first radio access network 130.

For the handover procedure, a target identifier identifying the second radio access network 140 can be sent from the terminal 120 to the first radio access network 130. The fictitious neighbor can be a means for providing a target identifier. The target identifier can be forwarded from the first radio access network 130 to the core network 110. The first radio access network 130 can also send a handover required message to the core network 110. Both the first radio access network 130 and the core network 110 can send an acknowledgement message to the second radio access network 140 to acknowledge the handover request. The terminal 120 can then be transferred to the second radio access network 140.

The method of this invention is preferably implemented on a programmed processor. However, the controllers may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the invention by simply employing the elements of the independent claims. Accordingly, the preferred embodiments of the invention as set forth herein are intended to be illustrative, not limiting. Various changes may be made without departing from the spirit and scope of the invention.

1. A method in a communication device for handover from a first radio access network to a second radio access network, the first radio access network using a different mode of communication from the second radio access network, the method comprising:
entering an ongoing communication on the first radio access network;
detecting a presence of a second radio access network, the second radio access network being unregistered with the first radio access network at initial detection of the presence of the second radio access network while in the ongoing communication; and
transferring the ongoing communication from the first radio access network to the second radio access network.

2. The method according to claim 1, wherein the first radio access network is a cellular radio access network and wherein the second radio access network is a wireless local area network.

3. The method according to claim 1, wherein the second radio access network is not associated with the first radio access network by the first radio access network not initially having information on the second radio access network.

4. The method according to claim 1, wherein entering an ongoing communication further comprises entering a call while operating in a serving cell of the first radio access network,
wherein the method further comprises:
transmitting a measurement report including a fictitious neighbor value.

5. The method according to claim 1, wherein the fictitious neighbor value includes one of
a same radio frequency value as a broadcast channel carrier of the serving cell including with a different color code from the broadcast channel carrier of the serving cell, and
a frequency value not used as a broadcast channel of the first radio access network of the serving cell.

6. The method according to claim 5, wherein the color code comprises an information field including a first three bits of a base station identity code.

7. The method according to claim 1, further comprising
setting up a data session with the second radio access network; and
querying the second radio access network for information relevant to a circuit handover.

8. The method according to claim 7, further comprising transmitting a message via a messaging service, the message including information on the second radio access network, the message indicating a desire to transfer the call from the first radio access network to the second radio access network.

9. The method according to claim 8, wherein the messaging service is a short messaging service and wherein the message is a short messaging service message.

10. A method in a radio access network for handover from a first radio access network to a second radio access network, the first radio access network using a different mode of communication from the second radio access network, the method comprising:
recognizing an ongoing call of the communication device in a serving cell on the first radio access network;
receiving a measurement report including an identifiable value associated with a serving cell of the first radio access network; and
transferring the call from the first radio access network to the second radio access network.

11. The method according to claim 10, wherein the identifiable value associated with the serving cell comprises a fictitious neighbor value.

12. The method according to claim 10, wherein the fictitious neighbor value comprises one of
a same frequency value as a broadcast channel carrier of the serving cell with a different color code from the broadcast channel carrier of the serving cell, and
a frequency value not used as a broadcast channel of the first radio access network of the serving cell.

13. The method according to claim 10, wherein the second radio access network comprises a wireless local area network and the first radio access network comprises a cellular radio access network, and
wherein the ongoing communication comprises one of a data session and a call.

14. The method according to claim 10, wherein the color code comprises an information field including a first three bits of a base station identity code.

15. The method according to claim 10, wherein the ongoing communication comprises a connection between the communication device and a connected party.

16. The method according to claim 10, wherein transferring the ongoing communication from the first radio access network to the second radio access network comprises switching the connection between the communication device and the connected party via the first radio access network to a connection between the communication device and the connected party via the second radio access network.

17. The method according to claim 10, wherein transferring the ongoing communication from the first radio access network to the second radio access network further comprises bypassing the first radio access network.

18. A communication device for handover from a first radio access network to a second radio access network, the first radio access network using a different mode of communication from the second radio access network, the communication device comprising:
a transceiver;
a controller coupled to the transceiver, the controller configured to enter an ongoing communication on the first radio access network via the transceiver;
a network detection module configured to detect the presence of a second radio access network, the second radio access network being unregistered with the first radio access network at initial detection of the presence of the second radio access network while in the ongoing communication; and
a handover module configured to transfer the ongoing communication from the first radio access network to the second radio access network.

19. The communication device according to claim 18, wherein the first radio access network is a cellular radio access network and wherein the second radio access network is a wireless local area network.

20. The communication device according to claim 18, wherein the second radio access network is unregistered with the first radio access network by the first radio access network not initially having information on the second radio access network when the network detection module detects the presence of the second radio access network.

21. The communication device according to claim 18, wherein the controller is configured to enter a the ongoing communication by entering a call while operating in a serving cell of the first radio access network, and
wherein the controller is further configured to generate and transmit a measurement report including a fictitious neighbor value associated with the serving cell.

22. The communication device according to claim 18, wherein the fictitious neighbor value includes one of
a same radio frequency value as a broadcast channel carrier of the serving cell including with a different color code from the broadcast channel carrier of the serving cell, and
a frequency value not used as a broadcast channel of the first radio access network of the serving cell.

23. The communication device according to claim 22, wherein the color code comprises an information field including a first three bits of a base station identity code.

24. The communication device according to claim 18, wherein the controller is further configured to set up a data session with the second radio access network and query the second radio access network for information relevant to a circuit handover.

25. The communication device according to claim 24, wherein the controller is further configured to transmit a message via a messaging service, the message including information on the second radio access network, the message indicating a desire to transfer the call from the first radio access network to the second radio access network.

26. The communication device according to claim 25, wherein the messaging service is a short messaging service and wherein the message is a short messaging service message.

27. A controller in a radio access network for handover from a first radio access network to a second radio access network, the first radio access network using a different mode of communication from the second radio access network, the controller comprising:
a communication connection module configured to connect an ongoing communication of the communication device in a serving cell on the first radio access network;
a measurement report module configured to receive a measurement report; and
a handover module configured to transfer the ongoing communication from the first radio access network to the second radio access network.

28. The controller according to claim 27, wherein the measurement report comprises a fictitious neighbor value.

29. The controller according to claim 28, wherein the fictitious neighbor value includes one of
a same radio frequency value as a broadcast channel carrier of the serving cell including with a different color code from the broadcast channel carrier of the serving cell, and
a frequency value not used as a broadcast channel of the first radio access network of the serving cell.

30. The controller according to claim 29, wherein the color code comprises an information field including a first three bits of a base station identity code.

31. The controller according to claim 27, wherein the second radio access network comprises a wireless local area network and the first radio access network comprises a cellular radio access network, and
wherein the ongoing communication comprises at least one of a data session and a call.

32. The controller according to claim 27, wherein the ongoing communication comprises a connection between the communication device and a connected party.

33. The controller according to claim 27, wherein the ongoing communication is transferred from the first radio access network to the second radio access network by switching the connection between the communication device and the connected party via the first radio access network to a connection between the communication device and the connected party via the second radio access network.

34. The controller according to claim 27, wherein the ongoing communication is transferred from the first radio access network to the second radio access network further by bypassing the first radio access network.
